(19) United States
(12) Patent Application Publication
(10) Pub. No.: US 2022/0142220 A1
(43) Pub. Date: May 12, 2022

(54) COFFEE ROASTING SYSTEM AND PROCESS

(71) Applicant: Ricconics LLC, Charlotte, NC (US)

(72) Inventor: Roderick M. Dayton, Charlotte, NC (US)

(21) Appl. No.: 17/581,875

(22) Filed: Jan. 22, 2022

Related U.S. Application Data
(63) Continuation of application No. PCT/US2020/043156, filed on Jul. 22, 2020.
(60) Provisional application No. 62/877,230, filed on Jul. 22, 2019.

(51) Int. Cl. A23N 12/10; A23N 12/12; F24C 15/32

(52) U.S. Cl. CPC A23N 12/10; G06K 7/1413; F24C 15/322; A23N 12/125

(57) ABSTRACT

A roaster and method for roasting coffee beans is provided, and includes a drum that extends axially along a rotational axis, and a motor that rotates the drum about the rotational axis. A bean inlet port is located adjacent to a first end of the drum, and receives coffee beans to be introduced to the drum for roasting. A heater generates a heated gas by elevating a temperature of a gas to at least a roasting temperature, and a nozzle directs the heated gas generally toward the coffee beans within the drum while the drum is rotated by the motor. A collection bin adjacent to a second end of the drum collects the coffee beans exiting the drum after the coffee beans are roasted by the heated gas while traveling through the drum between the inlet port and the collection bin.

### BACKGROUND OF THE INVENTION

### 1. Field of the Invention

This application relates generally to a method and apparatus for roasting coffee beans and, more specifically, to a method and apparatus for roasting coffee beans traveling along a rotating drum with a heated gas.

### 2. Description of Related Art

Consumers wishing to order coffee at a cafe, are typically presented with several different coffees selected by the café to be served that day. Examples of the coffee offerings commonly include drip coffee, pour over coffee, and espresso coffee drinks. Even though cafés can develop a model to predict the quantity of coffee they consume on a daily basis, there are often unexpected increases and decreases in demand that require the cafés to be able to quickly manage their supply of roasted coffee beans. Home roasters also desire to roast varying quantities of coffee beans at different times of year.

Conventional coffee roasters have traditionally utilized a roasting chamber defined by a heavy, often cast iron, body that is heated to a desired temperature for roasting. An agitator within the roasting chamber agitates the coffee beans within the roasting chamber, where the coffee beans are roasted at the desired temperature. Due in part to the large quantity of materials and complexities of such systems, coffee roasters for home use are typically limited to roasting coffee beans in batches of approximately half a pound, or less. Commercial coffee roasters offer larger roasting capacities, but cost much more than home-use coffee roasters.

Further, the high thermal mass of conventional roasters helps to maintain a constant temperature within the roasting chamber, but requires a substantial amount of time to get up to temperature. Because the roasting temperature is not easily or quickly adjustable for coffee roasters with a high thermal mass, roasting coffee beans with consistent results is also an artform that is largely dependent on manual adjustments of the coffee roaster made based on the experience and skill level of the person operating the coffee roaster. Further, traditional coffee roasters are also vented to an exterior environment to exhaust substantial quantities of smoke and odor generated as a result of the roasting process.

### BRIEF SUMMARY OF THE INVENTION

Accordingly, there is a need in the art for a method and apparatus for roasting different-sized batches of coffee beans. The present technology can include low thermal mass to allow for variable roasting parameters, according to some embodiments. According to alternate embodiments, the present technology can utilize recommended roasting information encoded by a computer-readable code to limit operator input to promote consistent roasting results, and/or allow for an exhaust gas to be vented into an interior environment.

For example, the present system and method can involve a roaster that includes a drum that extends axially along a rotational axis, and a motor that rotates the drum about the rotational axis. A bean inlet port is provided adjacent to a first end of the drum, so coffee beans to be roasted can be introduced to the drum through the bean inlet port. A heater generates a heated gas by elevating a temperature of a gas to at least a roasting temperature, and a nozzle directs the heated gas generally toward the coffee beans within the drum while the drum is rotated by the motor. A collection bin adjacent to a second end of the drum that collects the coffee beans exiting the drum after the coffee beans are roasted by the heated gas while the coffee beans travel through the drum between the inlet port and the collection bin.

According to some embodiments, the drum includes a perforated tube comprising a generally-cylindrical shape, that is arranged concentrically with the rotational axis. The nozzle can be offset from the rotational axis of the drum to direct a portion of the heated gas primarily toward portions of the perforated tube positioned at a first lateral side of the rotational axis. Thus, for such embodiments, the motor rotates the drum in a first angular direction about the rotational axis to cause the coffee beans within the drum to travel generally away from the nozzle while passing through a region on the first side of the rotational axis while the drum is rotating. The angular velocity can optionally be suitable to allow a portion of the coffee beans to fall, under a force of gravity, away from an internal surface of the drum on the first lateral side of the rotational axis.

According to some embodiments, the roaster can include a scanner that reads a computer-readable code associated with the coffee beans to be roasted. For example, the scanner can include a barcode reader, RFID tag antenna, etc. for reading a compatible computer-readable code applied to a bag or other container storing the coffee beans to be roasted. A control circuit in communication with the scanner can establish one or a plurality of roasting parameters of the roaster for roasting the coffee beans based on information obtained as a result of reading the computer-readable code.

According to another aspect, the coffee beans can optionally be roasted in the drum, and subsequently cooled while still in the drum. For example, embodiments of a heater provided to the coffee roaster can include a heating element that is operational to emit heat to elevate the temperature of the gas to at least the roasting temperature, and a blower is operable to blow the gas through the nozzle. A control circuit can deactivate the heating element and operate the blower during a cooling period to blow a cooling gas through the nozzle toward the coffee beans in the drum after the coffee beans have been exposed to the heated gas. The control circuit can be operatively coupled to the motor, to control operation of the motor and rotate the drum about the rotational axis during at least a portion of the cooling period, thereby circulating a portion of the coffee beans being exposed to the cooling gas within the drum. Accordingly, the coffee beans can be roasted and cooled in the drum according to some embodiments. Conventional coffee roasters with a roasting chamber having a high thermal mass would continue to heat, and therefore roast the coffee beans even after a heating element is deactivated.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 is a perspective view of a system for preparing coffee beans for consumption to prepare coffee drinks, in accordance with some embodiments;

FIG. 2 is a perspective view of a roaster that roasts coffee beans, the roaster forming a portion of a system for preparing coffee beans for consumption to prepare coffee drinks, in accordance with some embodiments;

FIG. 3 is a perspective view of a roaster that roasts coffee beans with portions of a cabinet partially cutaway, in accordance with some embodiments;

FIG. 4 is an end view of a drum of a roaster showing an offset of a nozzle from a rotational axis of the drum, and a fluidized bed of coffee beans during roasting in accordance with some embodiments;

FIG. 5 is an end view of a drum of a roaster, the drum comprising a helical coil within the drum that extends in an axial direction, along a portion of a length of the drum between a bean inlet port and a collection bin, to advance coffee beans along the length of the drum toward the collection bin, in accordance with some embodiments; and

FIG. 6 is an end view showing an embodiment of a second end of a drum, including a restrictor that interferes with a flow of coffee beans from the drum at the second end of the drum during roasting, but allowing chaff to escape the drum and be collected in a chaff collector.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

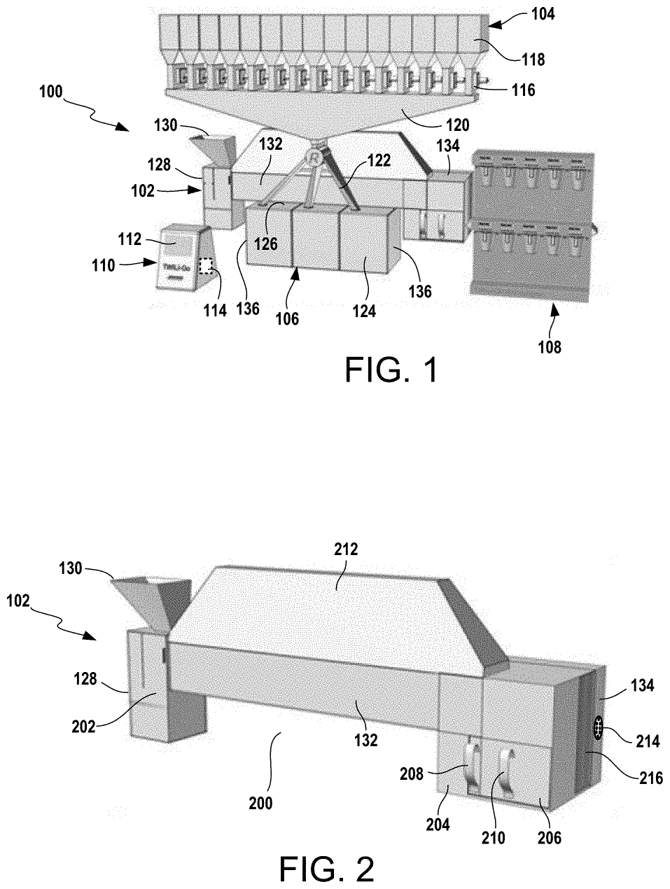

FIG. 1 shows an illustrative example of a system 100 for preparing coffee beans for consumption during the brewing of coffee drinks. The embodiment of the system 100 shown in FIG. 1 includes a plurality of modular components that can be installed and used individually, or in combination with at least one of the other modular components. For example, the system 100 can include at least one, and optionally a plurality of the following components: a roaster 102, a roasted coffee queue 104, a grinding and degassing stage 106, and a brewer 108. A control module 110 can include a scanner 112 and/or control circuitry 114 (shown in broken lines), and controls operation of one or more of the components included as part of the system 100.

Being modular, one or more of the components of the system 100 can be installed to cooperate with another one or more of the components of the system 100 to operate together, as part of a singular, integrated apparatus. For example, the roasted coffee queue 104 can be installed to supply roasted, whole coffee beans to the grinding and degassing stage 106. Such integration is an operable integration, where the product produced by one component is received by a second component without manual intervention other than possibly activating the process to be performed. For the example including the roasted coffee queue 104 integrated with the grinding and degassing stage 106, roasted, whole coffee beans are metered by a metering device 116 in communication with a respective bean hopper 118. The metering device 116 measures a defined quantity of coffee beans from the bean hopper 118, and deposits the measured quantity of coffee beans into a funnel 120 through which the deposited coffee beans fall under the force of gravity to a chute 122, which leads to a grinder and degasser 124. The grinder and degasser 124 grinds whole coffee beans into ground coffee to be used in brewing coffee drinks, and accelerates degassing, or removal, of a portion of carbon dioxide and/or other gases trapped in the ground coffee during the roasting process. An example of a grinder and degasser 124 is described in WIPO International Application No. PCT/US20/37827, which is incorporated in its entirety herein by reference.

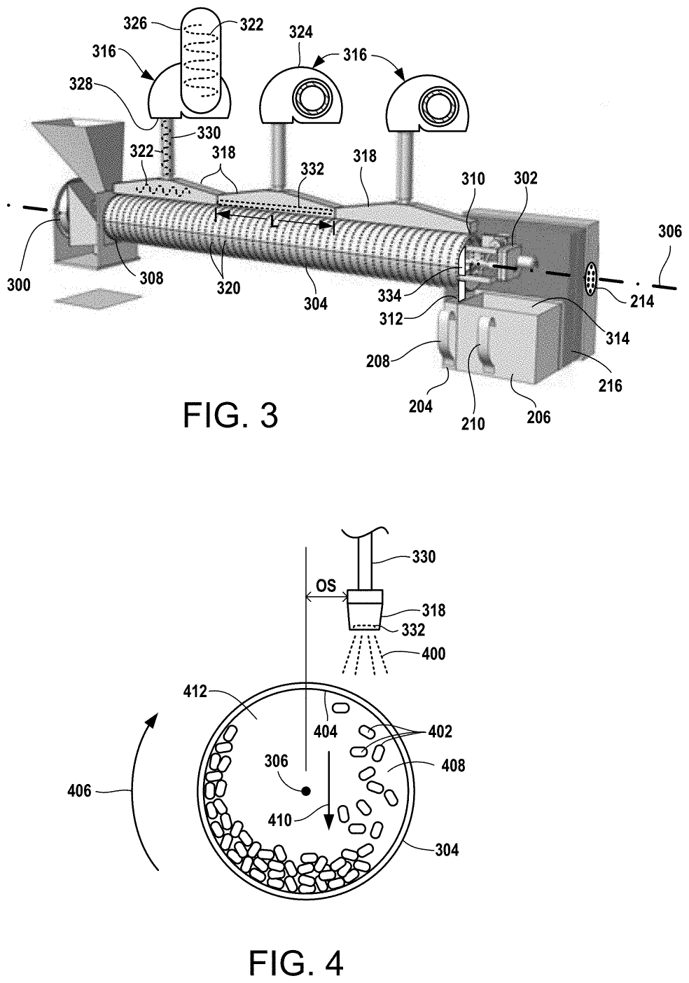

One or more components of the system 100 can optionally be physically integrated with one or more other components of the system 100. Operable integration involves the product of one component being delivered to a second component through automation. Physical integration involves arranging one component relative to a second component to conserve space where the system 100 is to be installed. For example, the embodiment of the roaster 102 shown in FIG. 1 is resting on a top surface 126 of a bank of the grinder and degasser 124 units. A first cabinet 128 housing a portion of a fan 300 (FIG. 3) and supporting a bean inlet port 130 is arranged adjacent to a first end of a drum housing 132, and a second cabinet 134 housing a portion of at least one of a motor 302, chaff collector 204 and a collection bin 206 (FIGS. 2 and 3). The weight of the roaster 102 can be supported by the top surface 126 of the grinder and degasser 124 bank. The first cabinet 128 and the second cabinet 134 can extend downward from the elevation of the drum housing 132, adjacent to lateral sides 136 of the grinder and degasser 124 bank, to define a notch 200, shown in FIG. 2, that at least partially receives the grinder and degasser 124 bank. Stacking the roaster 102 atop the grinder and degasser 124 bank conserves floorspace by occupying less surface area on the floor than separately arranging the roaster 102 and the grinder and degasser 124 bank as freestanding components.

An embodiment of the roaster 102 is shown separate from the overall system 100 in FIG. 2. As noted above, the drum housing 132 extends between a first cabinet 128 adjacent to a first end and a second cabinet 134 adjacent to a second end. The drum housing 132 at least partially encloses a drum 304, discussed below with respect to FIG. 3, and collects a portion of chaff, small beans and/or other byproducts of coffee beans being tumbled in the drum 304 while the drum 304 rotates as described herein. Embodiments of the drum housing 132 can be fully enclosed, to contain substantially all of the heated gas 400 (FIG. 4) directed toward the coffee beans in the drum 304 during roasting.

The first cabinet 128 defines an interior space that at least partially encloses the fan 300. The fan 300 is operable by the control module 110 to direct a forced airflow in an axial direction along a rotational axis 306 (FIG. 3) of the drum from a first end 308 of the drum 304, adjacent to the first cabinet 128, toward a second end 310 of the drum 304 adjacent to the second cabinet 134. Examples of the fan include, but are not limited to a multi-blade propeller fan, a centrifugal fan, a vanaxial fan, etc. A door 202 can be pivotally coupled to the first cabinet 128 by a hinge, for example, allowing the door 202 to be repeatedly opened and closed to gain access to the fan 300 in the interior space defined by the first cabinet 128.

The second cabinet 134 can define one or a plurality of separate compartments that receive at least one of the motor 302, a chaff collector 204 and a collection bin 206. Examples of the motor 302 include, but are not limited to an AC brushless motor, a DC brushed motor, a DC brushless motor, an induction motor, a synchronous motor, etc., that can be operated by the control module 110 to rotate the drum 304 as described herein.

The embodiments of the second cabinet 134 shown in FIGS. 2 and 3 include receivers that removably receive a chaff collector 204, which separates a portion of chaff from the coffee beans roasted within the drum 304, and a collection bin 206, which collects the roasted coffee beans. The chaff collector 204 can include a receptacle with an open top defining an aperture 312 (FIG. 3) through which chaff exiting the drum 304 at the second end 310 falls into the receptacle of the chaff collector 204. A handle 208 is coupled to the chaff collector 204 and exposed externally of the second cabinet 134 while the chaff collector 204 is received within the second cabinet 134, allowing the chaff collector 204 to be manually removed and emptied between roasts.

Chaff collected in the chaff collector 204 includes the dried skin on coffee beans, e.g., the husk, which flakes off the coffee beans when the coffee beans are exposed to elevated temperatures during the roasting process. Chaff constitutes a nuisance as a byproduct of the roasting process that has a light weight relative to the weight of coffee beans from which the chaff is removed. To mitigate the quantity of chaff that accumulates in the roaster 102, e.g., within the drum 304, drum housing 132, and/or collection bin 206, the control module 110 selectively activates the fan 300 to blow air in the axial direction along a length of the drum 304 from the first end 308 toward the second end 310 of the drum 304 during roasting. The air blown by the fan 300 forces at least a portion of the chaff approaching the second end 310 of the drum 304 to elevate within the drum 304, and escape the drum 304 during roasting over a top of a restrictor 600 (FIG. 6) arranged adjacent to the second end 310 of the drum 304.

The restrictor 600 can include a plate of a metal, metal alloy, polymeric, or other material that can withstand the temperatures to which the restrictor 600 is exposed during roasting. The restrictor 600 interferes with the flow of coffee beans 402 off the second end 310 of the drum as the drum 304 rotates during roasting. For the embodiment shown in FIG. 6, the restrictor 600 includes a shape that spans approximately 270° about the opening at the second end 310 of the drum 304, forming a dam that blocks coffee beans 402 from exiting the second end 310 of the drum 304 within that span. Coffee beans 402 collected behind the restrictor 600 (i.e., that remain in the drum 304) in FIG. 6 are shown in broken lines, representing objects hidden from view in FIG. 6 by the restrictor 600. The restrictor 600 defines an aperture forming an open window 602 spanning the remaining 90° of the opening at the second end 310. Because the chaff is relatively light, the air blown by the fan 300 elevates the chaff upward in the drum 304, and the relatively-heavy coffee beans remain resting on the inner surface 404 at the bottom of the drum 304. The elevated chaff escapes the drum 304 through the window 602 while the drum 304 rotates during roasting, as the coffee beans 402 are prevented by the restrictor 600 from exiting the drum 304 at the second end 310. As shown in FIG. 3, a baffle 334 is positioned adjacent to the window 602, blocking chaff exiting through the window 602 from reaching the collection bin 206. Instead, the chaff exiting through the window 602 contacts the baffle 334, and falls into the chaff collector 204, which can be manually removed from the second cabinet 134 and carried by the handle 208 to be disposed of. When roasting is complete and the roasted coffee beans 402 are to be deposited in the collection bin 206, the restrictor 600 can be rotated, pivoted, lifted, lowered, or otherwise moved by a motor controlled by the control module 110, or otherwise repositioned to allow the roasted coffee beans 402 to be deposited in the collection bin 206. The roasted coffee beans 402 exiting the drum 304 are not blocked by the baffle 334, and therefor flow into the collection bin 206. Accordingly, the chaff and the roasted coffee beans 402 can be separated.

Because the chaff is relatively light compared to the coffee beans, the chaff can be blown downward into the chaff collector 204 by forced air having a suitably-low velocity that the relatively-heavy coffee beans are not also blown into the chaff collector 204. The roasted coffee beans ejected at the second end 310 of the drum 304 are able to pass through the airflow blowing the chaff into the chaff collector 204, and fall under the force of gravity through an aperture 314 (FIG. 3) defined by a top of a container of the collection bin 206. For such embodiments, the chaff collector 204 is arranged between the second end 310 of the drum 304 and the collection bin 206. Like the chaff collector 204, the container of the collection bin 206 can also be coupled to a handle 210. The collection bin 206 receives the roasted coffee beans falling through the aperture 314 while the collection bin 206 is supported in the second cabinet 134, and is manually removable from the second cabinet 134 by the handle 210 to transport the roasted coffee beans from the roaster 102 to another component of the system 100 (e.g., a bean hopper 118 of the roasted coffee queue 104, the grinding and degassing stage 106, etc.).

FIG. 2 also shows an embodiment of a blower housing 212 that can optionally house a portion of at least one, or a plurality of heaters 316; and/or at least one, or a plurality of nozzles 318. The heater 316 is operable by the control module 110 to generate heat and create a forced airflow having an elevated temperature, referred to herein as a heated gas 400 (FIG. 4), that is to be directed toward coffee beans in the drum 304 during roasting. The heated gas 400 is directed by the one or more nozzles 318 through perforations 320 (FIG. 3) in the drum 304.

According to some embodiments, the heater 316 includes a heating element 322, shown as hidden lines in FIG. 3, that is operational to emit heat to elevate the temperature of a gas such as air, for example. Although the heating element 322 is shown as a coiled resistive element in FIG. 3, other examples of the heating element 322 include, but are not limited to, an inductive heating element of any physical configuration, an infrared heating element, etc. The heating element 322 can elevate a temperature of the heated gas 400 to at least a desired roasting temperature, such as any temperature of at least 140° C., or at least 150° C., or at least 160° C., or at least 170° C., or at least 180° C., or at least 190° C., or at least 200° C., etc. According to some embodiments, the heating element 322 can elevate a temperature of the heated gas 400 to a desired roasting temperature of up to 250° C., or up to 240° C., or up to 230° C., or up to 220° C., etc.

Embodiments of the heater 316 can also include a blower 324 that is operable by the control module 110 to create the forced airflow of the heated air having a suitable velocity to roast the coffee beans in the drum 304. Illustrative examples of the blower 324 include, but are not limited to a multi-blade propeller fan, a centrifugal fan, a vanaxial fan, etc. The illustrative embodiments of the blowers in FIG. 3 are shown with an inlet port 326 installed, and with the inlet port 326 removed. As shown in FIG. 3, the heating element 322 can be arranged within the air inlet port 326 to elevate the temperature of air being drawn into the blower 324. Thus, the air being drawing into the blower 324 can be heated by the heating element 322 into the heated gas 400, and subsequently accelerated by the blower 324 to establish a flow rate of the heated gas 400 suitable for roasting the coffee beans in the drum 304.

According to alternate embodiments, however, the heating element 322 can be disposed at any suitable location between an outlet 328 of the blower 324 and the drum 304 to elevate the temperature of air or another gas to generate the heated gas 400. For example, as shown in FIG. 3, the heating element 322 can optionally be installed within a portion of the nozzle 318, and/or within a conduit 330 instead of, or in addition to in the inlet port 326.

The control module 110 is operatively connected to the heating element 322, and can control operation of the heating element 322 independently of the blower 324 to blow the heated gas 400 and a cooling gas through the nozzle 318. For example, the control module 110 can deactivate the heating element 322 and concurrently operate the blower 324 during a cooling period to blow a cooling gas through the nozzle 318 toward the coffee beans in the drum 304 after the coffee beans have been exposed to the heated gas 400 and are sufficiently roasted. In other words, after the coffee beans are roasted to the desired roast level, the control module 110 operates the blower 324 without also operating the heating element 322, blowing room-temperature air or another cooling gas toward the coffee beans in the drum 304 during the cooling period.

To promote rapid and efficient cooling of the coffee beans during the cooling period, the control circuit module 110 can control operation of the motor 302 to rotate the drum 304 about the rotational axis 306 during the cooling period. For example, the control module 110 can control operation of the motor 302 to rotate the drum 304 about the rotational axis 306 during at least a portion of the cooling period, and thereby circulate a portion of the coffee beans being exposed to the cooling gas. Circulation of the coffee beans in the drum 304 can involve establishing a fluidized distribution of the coffee beans in the drum 304, as described herein.

The illustrative embodiment of the drum 304 shown in FIG. 3 includes a perforated tube constructed from a metal or metal alloy formed into a generally-cylindrical shape, to be aligned (optionally concentrically) with the rotational axis 306. For example, the drum 304 can be formed from a sheet of aluminum or aluminum alloy having a thickness of at least 1/16^{th} of an inch, up to ¼^{th} of an inch, or any other desired thickness, rolled into a generally-cylindrical shape. The drum 304 can have a diameter within a range from about four (4 in.) inches to about twelve (12 in.), with specific examples having a diameter within a range from about five (5 in.) to about seven (7 in.) inches. The length of the drum 304 in the axial direction along the rotational axis 306 can be within a range from about twelve (12 in.) inches to about fifty (50 in.) inches. The dimensions of the drum 304 can be chosen to accommodate different quantities of coffee beans in a single batch. For example, a roaster 102 configured to roast approximately three (3 lbs.) pounds to about four (4 lbs.) pounds per batch, can include a drum having a diameter of approximately five (5 in.) inches, and a length of approximately forty two (42 in.) inches. According to other embodiments, a ratio of the length of the drum 304 to the diameter of the drum 304 can fall within a range from about 1.75:1, to about 8.5:1. Such ratios represent

Being generally-cylindrical does not require an absolute cylindrical shape, but can also encompass slight deviations that do not cause the roaster 102 to vibrate when the drum 304 is rotated about the rotational axis 306. Perforations in the form of apertures forming through holes in the sheet of material allow the heated gas 400 and the cooling gas to enter the interior of the drum 304 as the drum 304 is rotated about the rotational axis 306 by the motor 302.

Some embodiments of the roaster 102 include one, or a plurality of nozzles 318 that extend longitudinally along a length of the drum 304 in a direction parallel with the rotational axis 306. In other words, a bottom of the nozzle(s) 318 can define an elongated aperture 332 having a length L, shown in FIG. 3, that extends in an axial direction of the drum 304, parallel with the rotational axis 306 of the drum 304.

FIG. 4 is an end view of an embodiment of a relationship between a nozzle 318 and a drum 304 of the roaster 102. For example, the nozzle 318 in FIG. 4 is laterally offset a distance OS from a position directly above the rotational axis 306 of the drum 304. Being laterally offset means that the nozzle 318 is arranged to direct heated gas 400 primarily toward portions of the perforated tube where coffee beans 402 are passing through a region to one lateral side of the rotational axis 306 of the drum 304, as the drum 304 is being rotated. As shown in FIG. 4, for example, the heated gas 400 is directed to portions of the perforated tube of the drum 304 primarily toward a fluidized bed of coffee beans 402 flowing through a semicircular region 408 to the right of the rotational axis 306. In other words, the nozzle 318 does not primarily direct (e.g., not concentrate) the heated gas 400 toward portions of the drum 304 that are aligned with the rotational axis 306 at the center of the drum 304. Instead, the nozzle 318 is positioned to direct the heated gas toward portions of the drum 304 at a non-orthogonal angle, having a tangential component, as shown in FIG. 4. The heated gas 400 passes through the perforations 320 of the drum 304 to roast the coffee beans 402.

Forming a fluidized bed of coffee beans 402 in the present embodiment, involves allowing the coffee beans 402, or at least a substantial portion thereof (e.g., most of, or at least 75% of the coffee beans 402 entering the semicircular region 408 to the right of the rotational axis 306 in FIG. 4) to fall away from an interior wall 404 of the drum 304, and generally away from the nozzle 318, as the drum 304 rotates about the rotational axis 306. The coffee beans 402 can fall under the force of gravity, or as a result of the combined force of gravity and the force imparted on the coffee beans 402 by the heated gas 400 emitted from the nozzle 318. For example, the drum 304 in FIG. 4 is rotated in the angular direction indicated by arrow 406 about the rotational axis 306. The motor 302 rotates the drum 304 in the angular direction 406 about the rotational axis 306 to cause the coffee beans 402 within the drum 304 to travel generally away from the nozzle 318 while passing through region 408 to the lateral right side of the rotational axis 306 while the drum 304 is rotating. Thus, the motor 302 can rotate the drum 304 at an angular velocity suitable to allow a portion of the coffee beans 402 to fall generally in the direction of arrow 410, under the force of gravity or the force of gravity and the force of the heated gas blown into the drum 304, away from the internal surface 404 of the drum 304. Although only a single nozzle 318 is shown in FIG. 4, the roaster 102 can optionally include a plurality of nozzles 318 laterally offset from the rotational axis 306 of the drum 304, as shown in FIG. 3. Each of the nozzles 318 can direct portions of the heated gas primarily toward portions of the perforated tube of the drum 304 positioned at the lateral side 408 of the rotational axis 306 of the drum 304.

The angular velocity of the drum 304 can be suitable to impart a centrifugal force on the coffee beans 402 that causes the coffee beans 402 to remain against the internal surface 404 as the coffee beans pass through a portion of the semicircular region to the left lateral side 412 of the rotational axis 306.

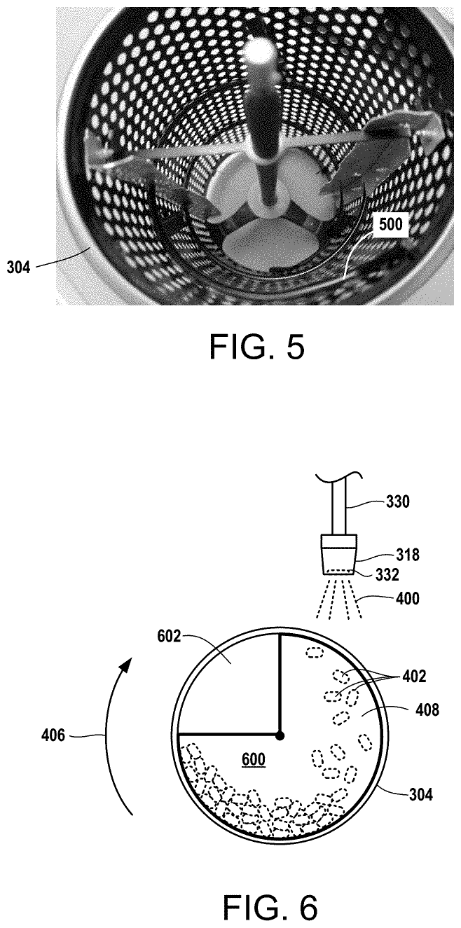

Coffee beans are introduced to the first end 308 of the drum 304 via the bean inlet port 130. As the drum 304 rotates the coffee beans progress along the length of the drum 340 toward the second end 310, where they are deposited from the drum 304 into the collection bin 206. As shown in FIG. 5, the drum 304 can optionally include a helical coil 500 that extends in an axial direction, along an interior surface within the drum 304. The helical coil 500 can extend along a portion of the length of the drum 304 between the bean inlet port 130 and the collection bin 206 to advance at least a portion of the coffee beans 402 along the length of the drum 304 toward the collection bin 206. For example, as the drum 304 rotates, the helical coil 500 coupled to the drum 304 is caused to rotate about the rotational axis 306. Rotation of the helical coil 500 forms a screw conveyor, advancing portions of the coffee beans 402 through the drum 304. The pitch of the helical coil 500 can be chosen to establish forward movement of coffee beans 402 through the drum 304 as a function of the drum's angular velocity.

Roasting coffee beans 402 can generate substantial quantities of smoke, carbon dioxide, and other constituents as byproducts, typically requiring a coffee roaster to be vented to an exterior environment. However, the present roaster 102 can optionally include an exhaust port 214 (FIGS. 2 and 3) through which the heated gas can be exhausted from the roaster 102 after being exposed to the coffee beans within the drum 304. The exhaust port 214 can be formed in a panel forming a portion of the second cabinet 134.

To limit the smoke and/or odor generated by the coffee roasting process, a filter 216 that removes a majority of smoke produced during roasting of the coffee beans entrained within the heated gas that has been exposed to the coffee beans can be disposed between the nozzle(s) 318 and the exhaust port 214. The filter 216 can include any filtration medium that is effective to remove a suitable portion of the smoke and/or odor from the heated gas to be exhausted from the roaster 102 to allow the heated gas to be vented into a room occupied by humans in a commercial environment. For example, the filter 216 can include activated charcoal, a HEPA filter, and the like to allow the heated gas to be vented through the exhaust port 214 into the room where the roaster 102 is located. For such embodiments, the filter 216 removes the smoke and/or odor from the heated gas before the heated gas is exhausted from the roaster 102 through the exhaust port 214.

Some embodiments of the control module 110 include a scanner 112 (FIG. 1) that reads a computer-readable code associated with the coffee beans to be roasted, to allow for one or more roasting parameters to be loaded into the roasting program, and automatically established by the roaster 102. For example, a bag or other container storing green coffee beans to be roasted can have a barcode, RFID tag, or other computer-readable code that can be interpreted by a machine equipped with the scanner 112. Examples of the roasting parameter(s) include, but are not limited to the roasting temperature of the heated gas 400 to be generated by the heater 316, a flow rate of the heated gas 400 directed by the nozzle(s) 318 generally toward the coffee beans 402 within the drum 304, and an angular velocity at which the drum 304 is rotated about the rotational axis 306.

Control circuitry 114 in communication with the scanner 112 receives a signal indicative of the computer-readable code interrogated by the scanner 112 and, in response, determines the roasting parameter to be established based on the received signal. For example, the control circuitry can include a computer-accessible memory storing a database of roasting parameters associated with a number, or a portion of a number, that is extracted by the control circuitry 114 based on the signal from the scanner 112. Referencing the database as a lookup table, for example, allows the control circuitry 114 to identify the roasting parameter to be established by the roaster 102 for roasting the respective coffee beans based on information obtained as a result of reading the computer-readable code.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A roaster for roasting coffee beans, the roaster comprising:
a drum that extends axially along a rotational axis;
a motor that rotates the drum about the rotational axis;
a bean inlet port adjacent to a first end of the drum, wherein coffee beans to be roasted are introduced to the drum through the bean inlet port;
a heater that generates a heated gas by elevating a temperature of a gas to at least a roasting temperature;
a nozzle that directs the heated gas generally toward the coffee beans within the drum while the drum is rotated by the motor; and
a collection bin adjacent to a second end of the drum that collects the coffee beans exiting the drum after the coffee beans are roasted by the heated gas while the coffee beans travel through the drum between the inlet port and the collection bin.

2. The roaster of claim 1, wherein the drum comprises a perforated tube comprising a generally-cylindrical shape concentric with the rotational axis, and the nozzle is offset from the rotational axis of the drum to direct a portion of the heated gas primarily toward portions of the perforated tube positioned at a first side of the rotational axis.

3. The roaster of claim 2, wherein the motor rotates the drum in a first angular direction about the rotational axis to cause the coffee beans within the drum to travel generally away from the nozzle while passing through the first side of the rotational axis while the drum is rotating.

4. The roaster of claim 3, wherein the motor rotates the drum at an angular velocity suitable to allow a portion of the coffee beans to fall, under a force of gravity, away from an internal surface of the drum on the first side of the rotational axis.

5. The roaster of claim 2, wherein the nozzle defines an elongated aperture through which the portion of the heated gas exits the nozzle and is directed primarily toward the portions of the perforated tube positioned at the first side of the rotational axis, wherein the elongated aperture extends along a longitudinal axis that is substantially parallel with the rotational axis of the drum.

6. The roaster of claim 2 further comprising a second nozzle that is offset from the rotational axis of the drum and directs another portion of the heated gas primarily toward portions of the perforated tube positioned at the first side of the rotational axis of the drum.

7. The roaster of claim 2 further comprising a helical coil within the drum that extends in an axial direction, along a portion of a length of the drum between the bean inlet port and the collection bin, wherein the helical coil advances a portion of the coffee beans along the length of the drum toward the collection bin.

8. The roaster of claim 1 further comprising:
a scanner that reads a computer-readable code associated with the coffee beans to be roasted; and
a control circuit in communication with the scanner to establish a roasting parameter to be established by the roaster for roasting the coffee beans based on information obtained as a result of reading the computer-readable code.

9. The roaster of claim 8, wherein the roasting parameter established by the control circuit comprises at least one of:
the roasting temperature of the heated gas generated by the heater;
a flow rate of the heated gas directed by the nozzle generally toward the coffee beans within the drum; and
an angular velocity at which the drum is rotated about the rotational axis.

10. The roaster of claim 8, wherein the computer-readable code comprises at least one of a barcode and a RFID tag applied to a container that stores the coffee beans to be roasted.

11. The roaster of claim 1 further comprising a fan positioned adjacent to the first end of the drum, wherein the fan generates an airflow in an axial direction parallel to the rotational axis through the drum to blow chaff from the coffee beans toward the second end of the drum.

12. The roaster of claim 11, wherein the chaff collector is arranged between the second end of the drum and the collection bin.

13. The roaster of claim 1, wherein the collection bin comprises a container into which the coffee beans that have been roasted and cooled in the drum fall into the container under a force of gravity after exiting the second end of the drum.

14. The roaster of claim 13, wherein the container receives the coffee beans that have been roasted while supported in a cabinet, and is removable from the cabinet to transport the coffee beans away from the roaster.

15. The roaster of claim 1, wherein the heater comprises:
a heating element that is operational to emit heat to elevate the temperature of the gas to at least the roasting temperature; and
a blower that blows the gas through the nozzle, wherein the roaster further comprises a control circuit that deactivates the heating element and operates the blower during a cooling period to blow a cooling gas through the nozzle toward the coffee beans in the drum after the coffee beans have been exposed to the heated gas.

16. The roaster of claim 15, wherein the control circuit is operatively coupled to the motor, and controls operation of the motor to rotate the drum about the rotational axis during at least a portion of the cooling period and circulate a portion of the coffee beans being exposed to the cooling gas.
